(19) United States
(12) Patent Application Publication
(10) Pub. No.: US 2004/0049306 A1
(43) Pub. Date: Mar. 11, 2004

(54) Simplified model creation assisting apparatus

(75) Inventor: Koichi Shimizu, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/649,729

(22) Filed: Aug. 28, 2003

(30) Foreign Application Priority Data
Aug. 30, 2002 (JP) 2002-252933

(51) Int. Cl. G06F 19/00

(52) U.S. Cl. 700/96

(57) ABSTRACT

A point on a surface of a detailed shape model is selected. Selected points are connected by lines, and a plane which is configured by the selected points, and the lines connecting the points as sides is finally formed when an instruction to create a plane is issued with a mouse. These operations are performed for the entire detailed shape model, whereby a simplified model the shape of which is simplified is created.

### BACKGROUND OF THE INVENTION

1. Field of the Invention

The present invention relates to a simplified model creation assisting apparatus assisting the creation of a simplified model when a numerical analysis of a structure that is represented by geometric shape data is made.

2. Description of the Related Art

Nowadays, the remarkable progress of an information processing device has been made, and a function equivalent to a mainframe of a decade ago has been implemented by a personal computer. With the popularization of such an information processing device, also a manufacturer that manufactures and designs a device has been introducing an information processing device with the aim of increasing work efficiency. Especially, a device design using an information processing device, which is called CAD, has been made broadly, and has come into general use.

The structure of a device, which is designed with a CAD machine, etc., and the like are stored as a collection of geometrical shape data. If a designer may arbitrarily determine the configuration of a device, there are no problems. Actually, however, there are items to be optimized, such as efficient dissipation of heat produced by part of a device, and the like in normal cases. In this case, the designer normally performs the procedures for making necessary simulation by using the structure data of the device created with a CAD machine, etc., and for modifying the structure of the device according to a simulation result. This simulation includes various types of numerical analyses such as a numerical analysis for the state of thermal conduction, a numerical analysis of the strength of a structure under various conditions, and the like. A program suitable for a particular numerical analysis is developed respectively for these numerical analyses.

A numerical analysis calculation using such a numerical analysis program (software) may be made by using geometrical shape data obtained from a CAD machine, etc. unchanged. However, as the shape becomes more complex, the amount of calculation becomes larger. Therefore, a lot of time is required to obtain one result, and such a calculation is impractical in many cases. In such a case, a geometrical shape is simplified to a certain extent in consideration of the trade-off between the accuracy of a numerical analysis and the complexity of a geometrical shape used in the numerical analysis.

Especially, for an electromagnetic field analysis among such numerical analyses, its calculation becomes very complex. Therefore, a model simplified from detailed shape data must be created. Fortunately, it is known that a configuration smaller than the wavelength of an electromagnetic field, which is used in a numerical calculation, exerts almost no influence if it is ignored in the numerical analysis of the electromagnetic field analysis. Accordingly, in the electromagnetic field analysis, analytic operations are normally performed after the configuration of an analysis target is significantly simplified, for example, by omitting or a significantly simplifying a configuration of a size equal to or smaller than a preset wavelength.

In this case, a simplified model must be created from the original detailed shape data. Conventionally, however, the coordinates of points of detailed shape data are displayed as a text, and the simplified model is created while copying the data displayed as the text to another file.

As described above, to create a simplified model from detailed shape data, a user who is expert in an electromagnetic field analysis empirically estimates how each portion of the detailed shape data influences on an analysis result, and creates a model where a portion determined to exert no influence is significantly simplified. However, such simplification largely depends on human senses, and besides, an operation to modify a simplified model is required. In addition, conventionally, the coordinate values of points of detailed shape data are displayed as a text to create a simplified model on a text level. Therefore, it requires more time to create a simplified model, as the detailed shape data represents a more complex shape, and the degree of simplification is higher. Furthermore, a simplified model is created by manipulating the coordinate values of points. Therefore, a user must perform the operations while imagining in his or her head the correspondence between the original detailed shape and the shape of the simplified model, leading to a problem that a heavy load is imposed on the user.

### SUMMARY OF THE INVENTION

An object of the present invention is to provide a simplified model creation assisting apparatus with good operability.

A simplified model creation assisting apparatus according to the present invention is a simplified model creation assisting apparatus used when a simplified model is created from a displayed detailed shape. This apparatus comprises: a selecting unit selecting a point on a displayed detailed shape; a generating unit generating a plane configured by selected points; and a model generating unit generating a simplified model corresponding to the detailed shape composed of data which indicates the generated plane.

According to the present invention, a simplified model corresponding to a detailed shape can be graphically created from the detailed shape on a display screen, whereby a user load imposed when the simplified model is created can be significantly reduced, and operation efficiency can be increased.

### BRIEF DESCRIPTION OF THE DRAWINGS

FIG. 1 is a schematic diagram (No. 1) explaining the concept of a process for selecting points and for forming a plane according to a preferred embodiment of the present invention;

FIG. 2 is a schematic diagram (No. 2) explaining the concept of a process for selecting points and for forming a plane according to the preferred embodiment of the present invention;

FIG. 3 is a schematic diagram exemplifying a simplified model display method;

FIG. 4 shows a display example (No. 1) of a simplified model creation screen according to the preferred embodiment of the present invention;

FIG. 5 shows a display example (No. 2) of the simplified model creation screen according to the preferred embodiment of the present invention;

FIG. 6 shows a display example (No. 3) of the simplified model creation screen according to the preferred embodiment of the present invention;

FIG. 7 is a flowchart explaining the process for creating points, sides, and a plane of a simplified model, according to the preferred embodiment of the present invention;

FIG. 8 is a schematic diagram exemplifying a user operation screen according to the preferred embodiment of the present invention;

FIG. 9 is a schematic diagram exemplifying a data creation/change dialog; and

FIG. 10 is a schematic diagram showing the hardware environment of an information processing device required to implement the preferred embodiment according to the present invention with a program.

### DESCRIPTION OF THE PREFERRED EMBODIMENTS

According to a preferred embodiment of the present invention, a point is created by selecting a point on the surface of a detailed shape model that is drawn three-dimensionally (for example, by assigning a selection function to a left button of a mouse beforehand, and by left-clicking the mouse), and the created point is highlighted.

Additionally, when a plurality of points are created by sequentially selecting the plurality of points (for example, by sequentially left-clicking the mouse), an edge is created for the second and subsequent points by connecting a line between a point created immediately before and a newly created point, and the created edge is highlighted. When an instruction to create a plane is issued (for example, by assigning the issuance of the instruction to create a plane to a right button of the mouse beforehand, and by right-clicking the mouse) after 3 edges are added, one plane configured by the 3 edges is created, and the highlighted points and edges are restored to a normal display. Furthermore, when the instruction to create a plane is issued (by right-clicking the mouse) after 4 edges are added, one plane configured by the 4 edges is created, and the highlighted points and edges are restored to a normal display.

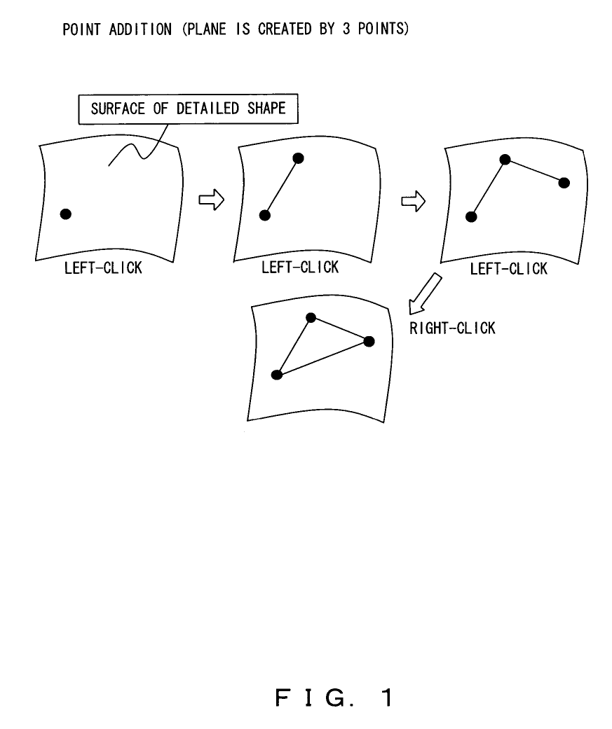

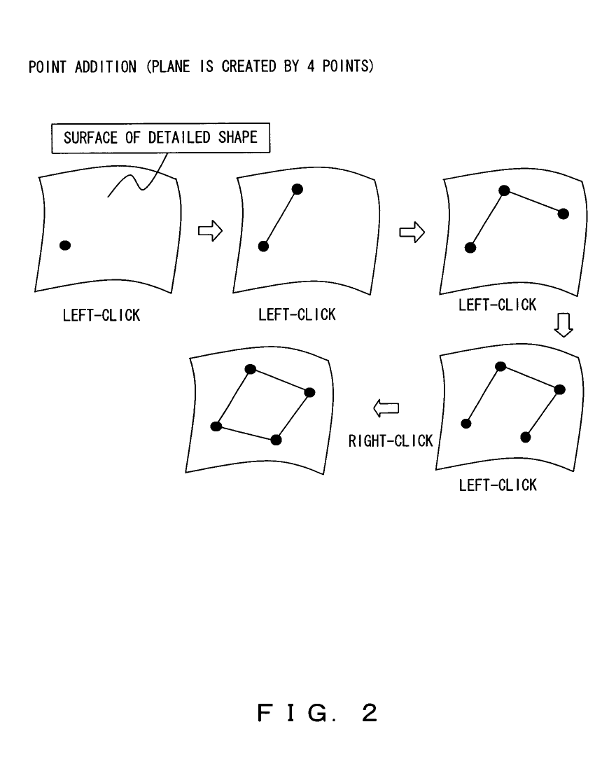

FIGS. 1 and 2 are schematic diagrams explaining the concept of a process for selecting points and for forming a plane according to the preferred embodiment of the present invention.

FIG. 1 shows the case where 3 points are selected on the surface of a detailed shape, and a triangle plane is created. The surface of the detailed shape is made to appear on a display, etc., and the points on the surface of the detailed shape are selected on the display. Specifically, a mouse pointer is moved to a predetermined position on the surface of the detailed shape, and a point on the surface of the detailed shape is selected, for example, by left-clicking the mouse. At this time, assumed as the coordinates of the point selected with the mouse pointer are coordinates (three-dimensional coordinates) within a virtual space at an intersection of a line, which is perpendicular to the display screen and dropped from the position of the mouse pointer on the display screen to the surface of the detailed shape within the virtual space, and the surface of the detailed shape.

Next, the second point is selected by moving the mouse pointer, and by left-clicking the mouse on the surface of the detailed shape, so that the coordinates of the second point are obtained, and at the same time, a line is drawn between the first and the second points. This line forms a side (edge) of a triangle plane to be formed later. Similarly, the third point is selected by moving the mouse pointer, and by left-clicking the mouse, so that the coordinates of the third point are obtained, and at the same time, a line is drawn between the second and the third points. When the instruction to create a plane is issued after the 3 points are selected, for example, by right-clicking the mouse while pointing to the position at which the plane is to be formed with the mouse pointer, the plane is formed by the selected 3 points. For the formed plane, the coordinates of the points on the circumference of the plane, the number of sides, a plane number for identifying a plane, etc. are generated as information.

FIG. 2 shows the case where a plane is formed by 4 points. In a similar manner as in FIG. 1, when the first point is selected (for example, by left-clicking a mouse while pointing to the position of the point to be selected with a mouse pointer) on the surface of a detailed shape, the coordinates of the first point are obtained. When the second point is selected, the coordinates of the second point are obtained, and at the same time, a line is drawn between the first and the second points. Similarly, when the third point is selected, the coordinates of the third point are obtained, and a line is drawn between the second and the third points. When the fourth point is selected, the coordinates of the fourth point are obtained, and a line is drawn between the third and the fourth points. When the instruction to create a plane is issued (for example, by right-clicking the mouse while pointing to the position at which the plane is to be formed with the mouse pointer) after the 4 points are selected, the plane surrounded by the 4 points is formed.

In the preferred embodiment according to the present invention, the procedures shown in FIGS. 1 and 2 are used as fundamental procedures, which are performed for all of surfaces of a detailed shape to be simplified, thereby creating a simplified model. In this way, a simplified model represented by a triangle or a quadrangle can be created. Note that, however, a simplified model is not required to be formed by a triangle or a quadrangle plane in all cases, and generally configured by a polygon.

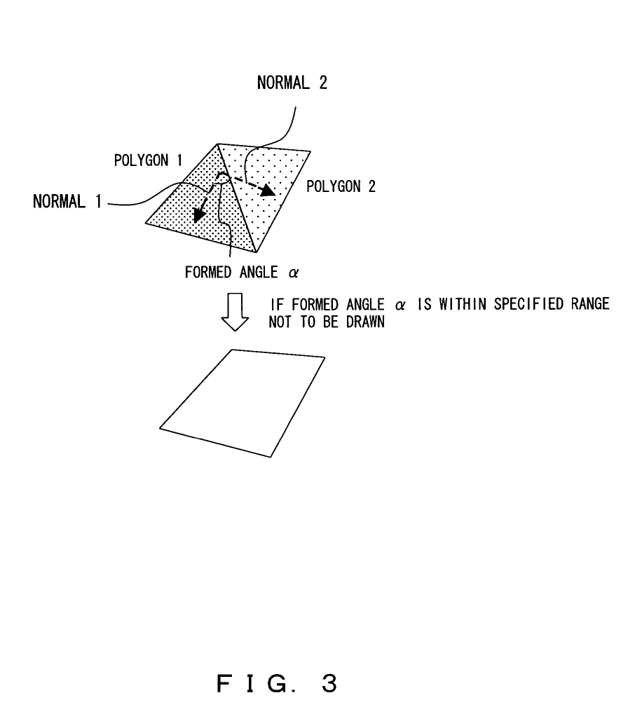

FIG. 3 is a schematic diagram exemplifying a simplified model display method.

This figure shows part of a simplified model that is represented by triangle planes. Here, if sides of all triangles (generally, polygons), which form a simplified model, are displayed when the simplified model is created, many lines are displayed, and the shape of the simplified model is difficult to be grasped. Accordingly, if an angle α, which is formed by normals of adjacent polygons among polygon planes (referred to as polygons. The triangle planes in the case shown in FIG. 3) forming the surfaces of the simplified model, is smaller than a predetermined value, the adjacent polygons are recognized to represent a smooth plane, and the side shared by the polygons is not displayed. In this way, 2 polygons are viewed as one polygon, a smooth change in the plane can be represented better, and the number of lines is reduced. Consequently, it becomes easy to recognize the shape of the simplified model.

If the angle α formed by the normals of the adjacent polygons is larger than the predetermined value, it indicates that the plane curves sharply. In this case, the side shared by the polygons is displayed. As a result, the state where the plane curves sharply can be recognized.

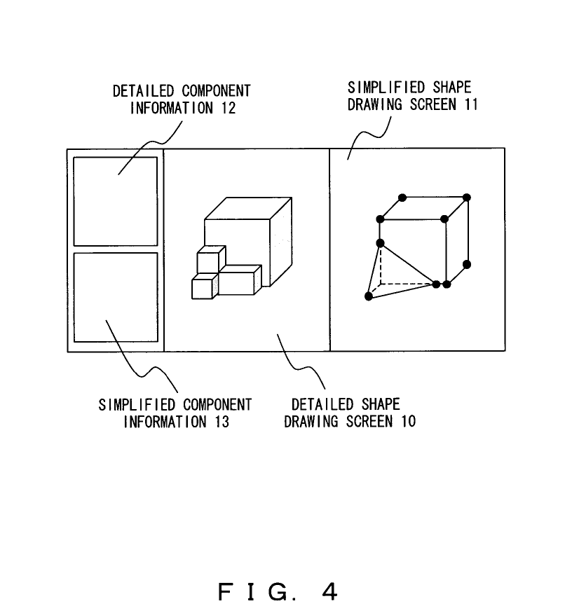

FIGS. 4 to 6 show display examples of a simplified model creation screen according to the preferred embodiment of the present invention.

FIG. 4 shows a first screen display example. In this figure, a screen for displaying the shape of a model that is represented by data of a detailed shape, and a screen for displaying the shape of a simplified model are respectively arranged. A user first makes the model of the detailed shape appear on a detailed shape drawing screen 10, and selects points on the model of the detailed shape with a mouse, etc. Then, the selected points are displayed on a simplified shape drawing screen 11. As described above, if a plurality of points are selected, the points are connected by lines. Namely, the points displayed on the simplified shape drawing screen 11 are connected by lines. When the user issues the instruction to create a plane, plane data composed of the identification number of a plane, the number of vertexes, the coordinates of the vertexes, and the like is generated. Also when the lines are drawn among the points, line data is generated for each of the lines. The line data is composed of the coordinates of points at both ends, the length of a line, and the like.

In a region of detailed component information 12, the data structure of the model of the detailed shape displayed on the detailed shape drawing screen 10 is made to appear. For example, if the model of the detailed shape is composed of a plurality of components, a tree data structure where the name of the model of the detailed shape is defined to be a root, and the names of the data of the components are listed is displayed. Furthermore, in a region of simplified component information 13, data for forming the simplified model that is displayed on the simplified shape drawing screen 11 is made to appear. The data of the simplified model is not structured as a tree, and point data, line data, and plane data are respectively listed.

In FIG. 4, a display of the detailed component information 12 and the simplified component information 13 is omitted.

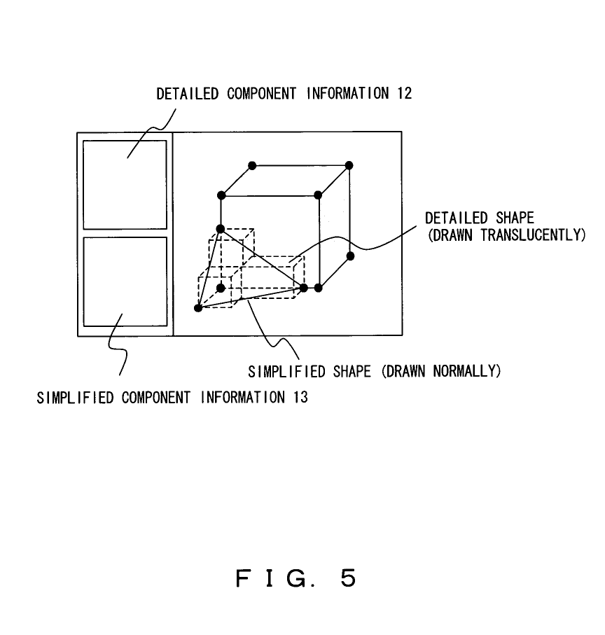

FIG. 5 shows a second display example. This figure shows a display example where a detailed shape and a simplified shape are overlaid and displayed, and operations are performed while verifying a result of an operation for obtaining the simplified shape from the detailed shape on the detailed shape. Since the detailed shape and the simplified shape are overlaid and displayed in this case, the detailed shape is drawn translucently. In the meantime, the simplified shape is drawn normally. Furthermore, the detailed shape and the simplified shape may be displayed in different colors in order to easily make a distinction between the shapes. Detailed component information 12 and simplified component information 13 are as described above.

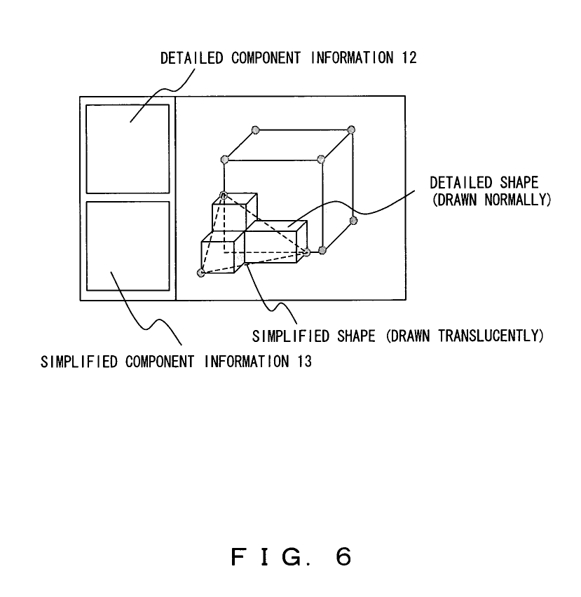

FIG. 6 shows a third display example. This figure shows a display example where the detailed shape that is drawn translucently in FIG. 5 is drawn normally, whereas the simplified shape that is drawn normally is drawn translucently. In a similar manner as in FIG. 5, the detailed shape and the simplified shape may be displayed in different colors in order to easily make a distinction between the shapes. Detailed component information 12 and simplified component information 13 are as described with reference to FIG. 4.

Any of the display methods shown in FIGS. 4 to 6 is available. However, it is desirable that these display methods maybe switched by a user specification. Switching is enabled, whereby the most suitable display method can be used in each phase of simplification. With any of these methods, the wholes of detailed and simplified shapes can be rotated by the same degrees without changing their relative positions.

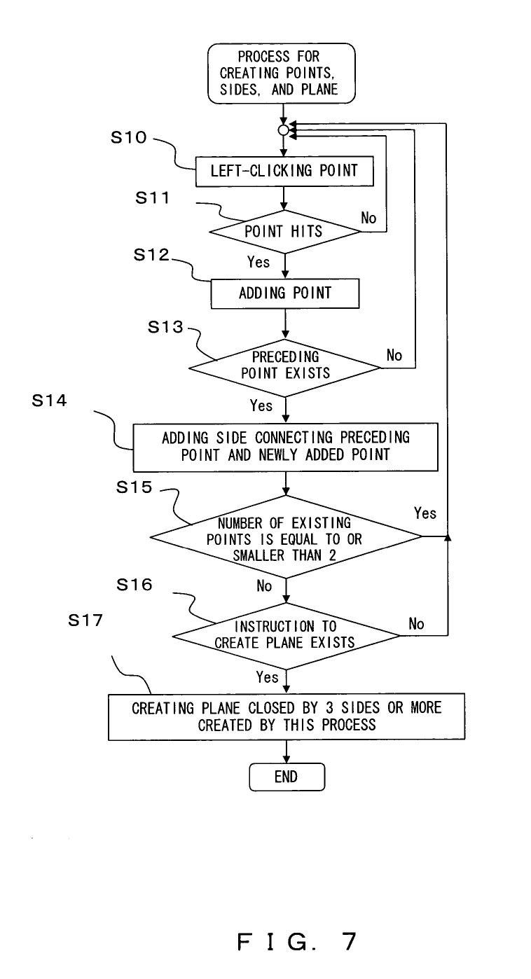

FIG. 7 is a flowchart explaining the process for creating points, sides, and a plane of a simplified model in the preferred embodiment according to the present invention.

Firstly, in step S10, a point is left-clicked (a point is selected). Next, in step S11, it is determined whether or not the point hits (the point is successfully selected). In this determination, a point hit is assumed to indicate that a selected point exists in a detailed shape. If the result of the determination made in step S11 is “YES”, the process returns to step S10. Or, if the result of the determination made in step S11 is “NO”, the process proceeds to step S12. In step S12, the currently selected point is added as the data of the simplified model. Then, in step S13, it is determined whether or not a point selected immediately before the currently selected point exists.

If the result of the determination made in step S13 is “NO”, the process returns to step S10. If the result of the determination made in step S13 is “YES”, a side connecting the point selected immediately before and the newly added point is added to the data of the simplified model. Then, in step S15, it is determined whether or not the number of points existing in the data of the simplified model up to the current time point is equal to or smaller than 2. If the result of the determination made in step S15 is “NO”, the process returns to step S10. If the result of the determination made in step S15 is “YES”, the process proceeds to step S16. In step S16, it is determined whether or not the instruction to create a plane (right-click) exists. If the result of the determination made in step S16 is “NO”, the process returns to step S10. If the instruction to create a plane is determined to exist in step S16, the plane closed by 3 sides or more, which are created by the above described process, is created, and the process is terminated.

The data of a simplified model in the preferred embodiment according to the present invention is composed of point data (X coordinate, Y coordinate, Z coordinate), side data (point number 1, point number 2), and plane data (side number 1, side number 2, side number 3, side number 4). As the data of a simplified model, it is not always necessary to generate these three types of data. Only data required for the process may be generated.

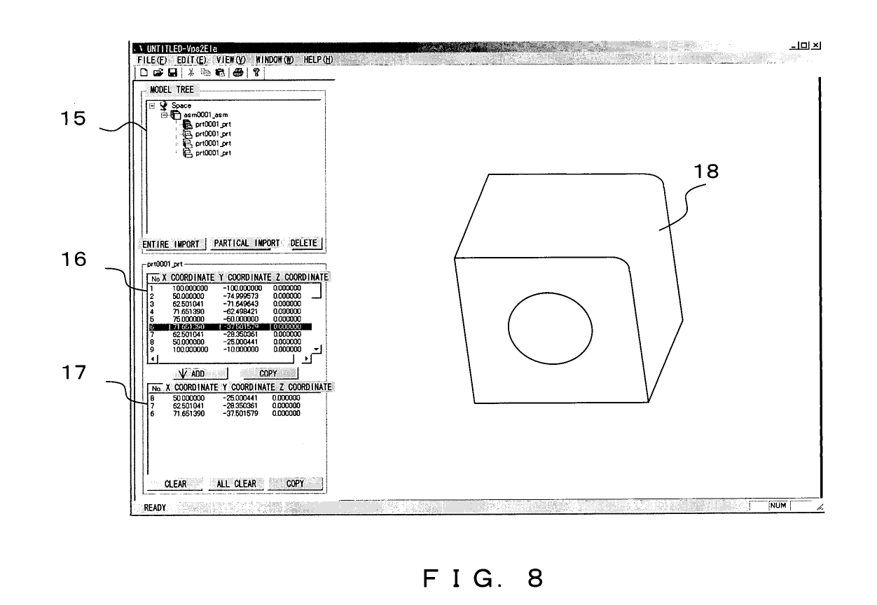

FIG. 8 is a schematic diagram exemplifying a user operation screen according to the preferred embodiment of the present invention.

In this figure, a detailed shape model 18 is displayed on the front of a screen, and the data structure of the detailed shape model is displayed in a region of detailed shape component information 15 as a graphic of a tree structure. Furthermore, coordinates data of points of a simplified model, and coordinates data of newly added points are respectively displayed in 16 and 17 as simplified shape component information. A user creates a simplified model by selecting points on the detailed shape model 18 with a mouse pointer, etc. If a new point is added at this time, its coordinate data is displayed in the regions of 16 and 17 on the left of the screen shown in FIG. 8.

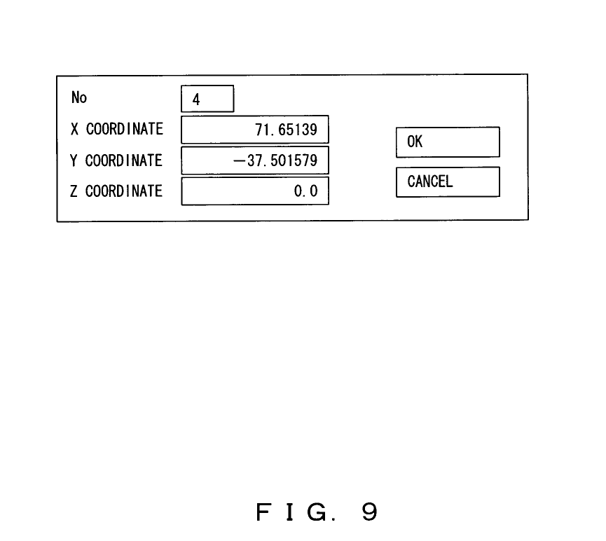

FIG. 9 exemplifies a data creation/change dialog.

If a listing line of an added point is selected (for example, by double-clicking the mouse) on the screen of FIG. 8, the dialog shown in FIG. 9 is displayed. Here, a specific point number, and X, Y, and Z coordinate values of the added point are displayed. If a user desires to change the coordinate values, he or she changes a numerical value with the dialog shown in FIG. 9, and presses an OK button, so that the positional coordinates of the added point can be moved.

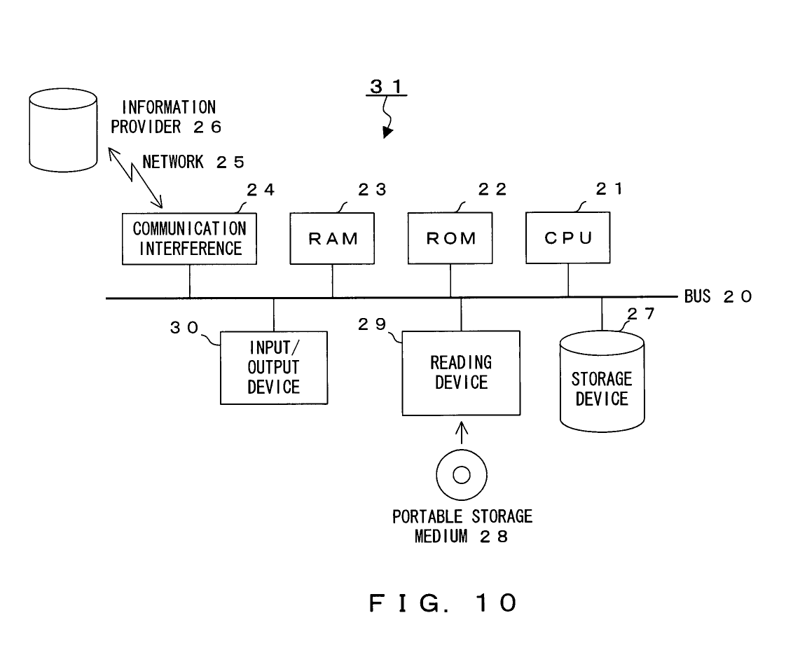

FIG. 10 is a schematic diagram showing the hardware environment of an information processing device required to implement the preferred embodiment according to the present invention with a program.

A CPU 21 executes a program stored in a ROM 22 or a RAM 23 via a bus 20. The program stored in the RAM 23 is copied from a storage device 27 such as a hard disk, etc. via the bus 20. Or, the program is read by a reading device 28 from a portable storage medium 29 such as a CD-ROM, a DVD, an MO, a flexible disk, etc., and copied via the bus 20.

An input/output device 30 is a device such as a display, a keyboard, a mouse, a template, etc., with which a user of an information processing device 31 transmits an instruction to the CPU 21, and receives an arithmetic operation result of the CPU 21.

A communications interface 24 connects the information processing device 31 to an information provider 26 via a network 25 in order to enable the program to be downloaded or executed under the network environment.

According to the present invention, a simplified model can be created from a detailed shape model with an easy method, and the operation efficiency of a numerical analysis can be increased.

What is claimed is:

1. A simplified model creation assisting apparatus used when a simplified model is created from a displayed detailed shape, comprising:
a selecting unit selecting a point on a displayed detailed shape;
a generating unit generating a plane configured by selected points; and
a model generating unit generating a simplified model corresponding to the detailed shape composed of data which indicates the generated plane.

2. The simplified model creation assisting apparatus according to claim 1, wherein
a selection of the point is graphically made with a mouse pointer.

3. The simplified model creation assisting apparatus according to claim 1, wherein the simplified model is configured by a plurality of polygons.

4. The simplified model creation assisting apparatus according to claim 3, wherein
the plurality of polygons are triangles.

5. The simplified model creation assisting apparatus according to claim 3, wherein
the plurality of polygons are quadrangles.

6. The simplified model creation assisting apparatus according to claim 1, wherein
a selection of the point is made on a display screen on which a detailed shape is displayed, and a simplified model configured by selected points is displayed in a display region different from the detailed shape.

7. The simplified model creation assisting apparatus according to claim 1, wherein
a selection of the point is made on a display screen on which a detailed shape is displayed, and a simplified model configured by selected points is overlaid on the detailed shape, and displayed.

8. The simplified model creation assisting apparatus according to claim 7, wherein
one of the simplified model and the detailed shape is drawn translucently, the simplified model and the detailed shape are displayed in different colors, or one of the simplified model and the detailed shape is drawn translucently and the simplified model and the detailed shape are displayed in different colors.

9. A simplified model creation assisting method used when a simplified model is created from a displayed detailed shape, comprising:
selecting a point on a displayed detailed shape;
generating a plane configured by selected points; and
generating a simplified model corresponding to the detailed shape composed of data which indicates the generated plane.

10. The simplified model creation assisting method according to claim 9, wherein
a selection of the point is graphically made with a mouse pointer.

11. The simplified model creation assisting method according to claim 9, wherein
the simplified model is configured by a plurality of polygons.

12. The simplified model creation assisting method according to claim 11, wherein
the plurality of polygons are triangles.

13. The simplified model creation assisting method according to claim 11, wherein
the plurality of polygons are quadrangles.

14. The simplified model creation assisting method according to claim 9, wherein
a selection of the point is made on a display screen on which a detailed shape is displayed, and a simplified model configured by selected points is displayed in a display region different from the detailed shape.

15. The simplified model creation assisting method according to claim 9, wherein
a selection of the point is made on a display screen on which a detailed shape is displayed, and a simplified model configured by selected points is overlaid on the detailed shape, and displayed.

16. The simplified model creation assisting method according to claim 15, wherein
one of the simplified model and the detailed shape is drawn translucently, the simplified model and the detailed shape are displayed in different colors, or one of the simplified model and the detailed shape is drawn translucently and the simplified model and the detailed shape are displayed in different colors.

17. A simplified model creation assisting program used when a simplified model is created from a displayed detailed shape, which causes an information processing device to execute a simplified model creation assisting method, the method comprising:
selecting a point on a displayed detailed shape;
generating a plane configured by selected points; and
generating a simplified model corresponding to the detailed shape composed of data which indicates the generated plane.

18. The simplified model creation assisting program according to claim 17, wherein
a selection of the point is graphically made with a mouse pointer.

19. The simplified model creation assisting program according to claim 17, wherein
the simplified model is configured by a plurality of polygons.

20. The simplified model creation assisting program according to claim 19, wherein
the plurality of polygons are triangles.

21. The simplified model creation assisting program according to claim 19, wherein
the plurality of polygons are quadrangles.

22. The simplified model creation assisting program according to claim 17, wherein
a selection of the point is made on a display screen on which a detailed shape is displayed, and a simplified model configured by selected points is displayed in a display region different from the detailed shape.

23. The simplified model creation assisting program according to claim 17, wherein
a selection of the point is made on a display screen on which a detailed shape is displayed, and a simplified model configured by selected points is overlaid on the detailed shape, and displayed.

24. The simplified model creation assisting program according to claim 23, wherein
one of the simplified model and the detailed shape is drawn translucently, the simplified model and the detailed shape are displayed in different colors, or one of the simplified model and the detailed shape is drawn translucently and the simplified model and the detailed shape are displayed in different colors.

25. The simplified model creation assisting(?) apparatus according to claim 1, wherein
the data which indicates the generated plane is composed of data of the selected points, data of lines connecting the points, and data of a plane of a region enclosed by the points and the lines.

26. The simplified model creation assisting method according to claim 9, wherein
the data which indicates the generated plane is composed of data of the selected points, data of lines connecting the points, and data of a plane of a region enclosed by the points and the lines.

27. The simplified model creation assisting program according to claim 17, wherein
the data which indicates the generated plane is composed of data of the selected points, data of lines connecting the points, and data of a plane of a region enclosed by the points and the lines.
